(19) United States
(12) Patent Application Publication
(10) Pub. No.: US 2004/0087322 A1
(43) Pub. Date: May 6, 2004

(54) Mobile telephone relaying system

(76) Inventor: A. L. Pepper Aasgaard, Omaha, NE (US)

Correspondence Address: SUITER WEST PC LLO, 14301 FNB PARKWAY, SUITE 220, OMAHA, NE, 68154, US

(21) Appl. No.: 10/692,942

(22) Filed: Oct. 24, 2003

Related U.S. Application Data
(60) Provisional application No. 60/421,265, filed on Oct. 25, 2002.

(51) Int. Cl. H04Q 7/20

(52) U.S. Cl. 455/462; 455/550.1; 455/422.1

(57) ABSTRACT

The present invention is directed to a mobile telephone relaying system or unit for relaying communication signals between a mobile telephone capable of wireless communication with a wireless mobile telephone communication system and a wired telephone in a wired local telephone network providing communication between the wired telephone and a wired telephone communication system for allowing communication via the wired telephone using the wireless telephone network. According to an exemplary aspect of the present invention, a mobile telephone relaying unit may be coupled to the wired home telephone network for relaying communication signals between the mobile telephone and the wired local telephone network for communication with the wired telephone. The wired telephone network may employ communication signals having a first format, and the mobile telephone communication signals may have a second format. The relaying unit may convert communication signals received from the mobile telephone from the second format to the first format for transmission to the wired local telephone network, and may convert communication signals received from the wired local telephone network by the wired telephone from the first format to the second format for transmission to the mobile telephone.

### CROSS-REFERENCE TO RELATED DOCUMENTS

The present application claims the benefit under 35 U.S.C. § 119(e) of U.S. Provisional Application Serial No. 60/421,265, filed Oct. 25, 2002. Said U.S. Provisional Application Serial No. 60/421,265 is herein incorporated by reference in its entirety.

### FIELD OF THE INVENTION

This invention relates generally to the field of telecommunication, and particularly to a mobile telephone relaying system for relaying communication signals between a mobile telephone capable of wireless communication with a wireless mobile telephone communication system and a wired telephone in a wired local telephone network providing communication between the wired telephone and a wired telephone communication system.

### BACKGROUND OF THE INVENTION

There are currently two main categories of telephones: (1) wired telephones, including landline based telephones and a cordless telephones, and (2) mobile telephones including cellular telephones, wireless enabled devices, and the like. Wired telephones utilize fixed telephone lines (e.g., a wired local telephone network within the home or office and a wired telephone communication system) to transmit communication signals and are mostly used in the home and the office. Cordless telephones include a base unit which is connected to a telephone landline and communicated with a remote handset by low power radio. This may permit use of the handset of a cordless telephone from a location within a certain range (e.g., less than 50 meters) of the base unit. Mobile telephones utilze a wireless mobile telephone communication system that uses a combination of radio wave transmission and conventional telephone switching to permit telephone communication to and from mobile users within a specified area. The most common mobile telephone is the cellular telephone or cell phone, which receives or sends messages through a base station having a transmission tower (or tower). Radio waves are often used to transfer signals to and from a cell telephone. Communication between cells may be wireless, or over ground cables. Most mobile telephone systems are cell-structured. Alternateively, mobile telephones include satellite telephones which do not use mobile technology. The wired telephone communication system and wireless telephone communication system are combined to form the PSTN (public switched telephone network), which connects most telephones (wired and mobile) together.

Many telephone users utilize a mobile telephone in addition to a wired telephone in the user's home or office. However, the mobile telephone and wired telephone are unable to communicate directly with one another, other than through the PSTN. Thus, for example, the telephone user is unable to answer incoming telephone calls received on the user's mobile telephone using the user's wired telephone, and, conversely, is unable to answer incoming telephone calls received on the user's wired telephone using the user's mobile telephone. This non-connection of the mobile telephone and the wired telephone often causes great inconvenience. For example, the user may accidently leave the mobile telephone in an upstairs bedroom while the user is in the downstairs living room. In order to answer the mobile telephone, the user must go upstairs, locate the mobile telephone, and answer it, even though the living room may contain a wired telephone. It would be extremely convenient if the user could answer the mobile telephone from the wired telephone in the living room. In addition, many mobile telephone service providers conventionally provide a free long distance telephone call plan to the mobile telephone service subscriber. In contrast, long distance telephone call companies generally do not provide similar service to a user of a wired telephone. Thus, for a user of both a mobile telephone and a wired telephone, it would be convenient and cost effective if the user could use the wired telephone to make a free long distance telephone call through the mobile telephone via the wireless mobile telephone system, utilizing the mobile telephone's free long distance telephone calling plan.

Accordingly, it would be desirable to provide a mobile telephone relaying system for relaying communication signals between a mobile telephone capable of wireless communication with a wireless mobile telephone communication system and a wired telephone in a wired local telephone network providing communication between the wired telephone and a wired telephone communication system for allowing communication via the wired telephone using the wireless telephone network.

### SUMMARY OF THE INVENTION

The present invention is directed to a mobile telephone relaying system or unit for relaying communication signals between a mobile telephone capable of wireless communication with a wireless mobile telephone communication system and a wired telephone in a wired local telephone network providing communication between the wired telephone and a wired telephone communication system for allowing communication via the wired telephone using the wireless telephone network.

According to an exemplary aspect of the present invention, a mobile telephone relaying system for relaying communication signals between a mobile telephone capable of wireless communication with a wireless mobile telephone communication system and a wired telephone in a wired local telephone network providing communication between the wired telephone and a wired telephone communication system, may include a relaying unit coupled to the wired home telephone network for relaying communication signals between the mobile telephone and the wired local telephone network for communication with the wired telephone. The wired telephone network may employ communication signals having a first format, and the mobile telephone communication signals may have a second format. The relaying unit may convert communication signals received from the mobile telephone from the second format to the first format for transmission to the wired local telephone network, and may convert communication signals received from the wired local telephone network by the wired telephone from the first format to the second format for transmission to the mobile telephone. The relaying device may also enable two or more mobile telephones and two or more wired phones to communicate with each other.

It is to be understood that both the foregoing general description and the following detailed description are exemplary and explanatory only and are not restrictive of the invention as claimed. The accompanying drawings, which are incorporated in and constitute a part of the specification, illustrate an embodiment of the invention and together with the general description, serve to explain the principles of the invention.

### BRIEF DESCRIPTION OF THE DRAWINGS

The numerous advantages of the present invention may be better understood by those skilled in the art by reference to the accompanying figures in which:

FIG. 1 is a schematic diagram of an exemplary telephone network in which the present invention may be implemented;

FIG. 2 shows an exemplary telephone network including a mobile telephone relaying device at the user's end in accordance with an exemplary embodiment of the present invention;

FIG. 3A shows an exemplary telephone network including a mobile telephone relaying device at a user's home in accordance with an exemplary embodiment of the present invention;

FIG. 3B shows an alternative exemplary telephone network including a mobile telephone relaying device at a user's home in accordance with an exemplary embodiment of the present invention;

FIG. 3C shows another telephone network including a mobile telephone relaying device at a user's home in accordance with an exemplary embodiment of the present invention;

FIG. 3D shows a further exemplary telephone network including a mobile telephone relaying device at a user's home in accordance with an exemplary embodiment of the present invention;

FIG. 4 shows an exemplary structure of a mobile telephone relaying device in accordance with an exemplary embodiment of the present invention;

FIG. 5 is a flow chart showing a process for routing an incoming telephone call in accordance with an exemplary embodiment of the present invention;

FIG. 6 is a flow chart showing a process for routing an outgoing telephone call in accordance with an exemplary embodiment of the present invention;

FIG. 7A shows an exemplary telephone network where an incoming telephone phone call is received by a mobile phone in accordance with an exemplary embodiment of the present invention;

FIG. 7B shows an additional exemplary telephone network where an incoming telephone phone call is received by a mobile phone in accordance with an exemplary embodiment of the present invention; and

FIG. 8 shows an exemplary telephone network where an outgoing telephone phone call is made from a wired telephone in accordance with an exemplary embodiment of the present invention.

### DETAILED DESCRIPTION OF THE INVENTION

Reference will now be made in detail to the presently preferred embodiments of the invention, examples of which are illustrated in the accompanying drawings.

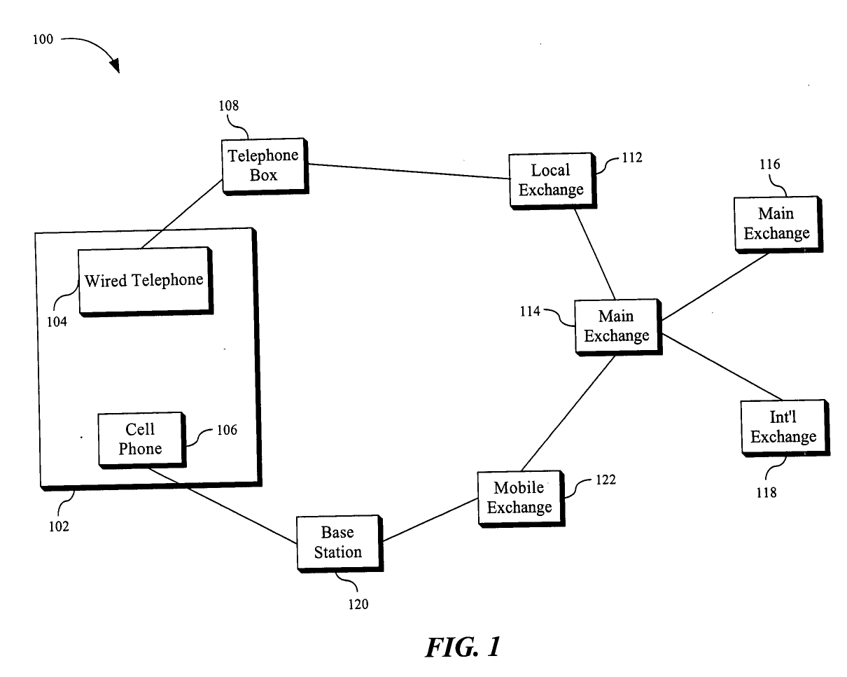

Referring first to FIG. 1, an exemplary telephone network 100 in which the present invention may be implemented is shown. The telephone network 100 may be part of the PSTN (public switched telephone network). At a user's end 102 such as a home, an office, a workstation, or the like, the user may have a wired telephone 104 such as a regular telephone, a cordless telephone, or the like, and a cellular telephone 106. The wired telephone 104 may be communicatively coupled to a local exchange 112 via a telephone box 108. The local exchange 112 is a building where the local telephone switch is located. The local exchange 112 may be connected to all the wired telephones in a small geographic area. The local exchange 112 may be communicatively coupled to another local exchange (not shown) and a first main exchange 114 (a building where the main exchange switch is located). The main exchange 114 may be communicatively coupled to a second main exchange 116 and an international exchange 118. The international exchange 118 may be communicatively coupled to another international exchange (not shown) via a satellite, an undersea cable, or the like. The cell phone 106 is communicatively coupled to a base station 120 having a transmission tower. A mobile exchange 122 may be communicativley coupled to the base station 120 and other base stations (not shown) in a geographic region such as a city or the like. The mobile exchange 122 is also called the mobile telephone switching office (MTSO) and controls all of the base stations in the region. The mobile exchange 122 is communicativley coupled to the main exchange 114.

When a user makes a telephone call from the wired telephone 104, the telephone call (or the communication signal) may leave the user's end 102 and travel to the local exchange 112 via the telephone box 108. If the telephone call is a local call having a destination for which the local exchange 112 is responsible, the local exchange 112 may route the call directly to the destination. If the telephone call is a local call having a destination for which the local exchange 112 is not responsible, the local exchange 112 may route the call to the local exchange which is responsbile for the destination. If the telephone call is not a local call, then the local exchange 112 may route the call to the main exchange 114. The main exchange 114 may then route the telephone call to another main exchange, the international exchange 118, or the mobile exchange 122, depending on the destination of the telephone call.

When a user makes a telephone call from the cell phone 106, the telephone call may first travel to the base station 120 and then to the mobile exchange 122. If the telephone call is to another cell phone to which the mobile exchange 122 is responsible to forward the telephone call, the mobile exchange 122 may route the call directly to that cell phone. If the telephone call is to a wired telephone, then the mobile exchange 122 may first route the call to the main exchange 114, which may then route the call to an appropriate exchange, depending on the destionation of the telephone call.

As shown in FIG. 1 and described above, the cell phone 106 and the wired telephone 104 each use separate routes (a wired telephone route and a cell phone route) to forward outgoing telephone calls and receive incoming telephone calls. The main exchange 114 acts as an connection point for these two separate routes. However, this conventional telephone network 100 does not provide means at the user's end 102 for communicating the cell phone 106 with the wired telephone 104. Thus, the user may not be able to answer an incoming telephone call received on the cell phone 106 using the wired telephone 104, or may not be able to answer an incoming telephone call received on the wired telephone 104 using the cell phone 106.

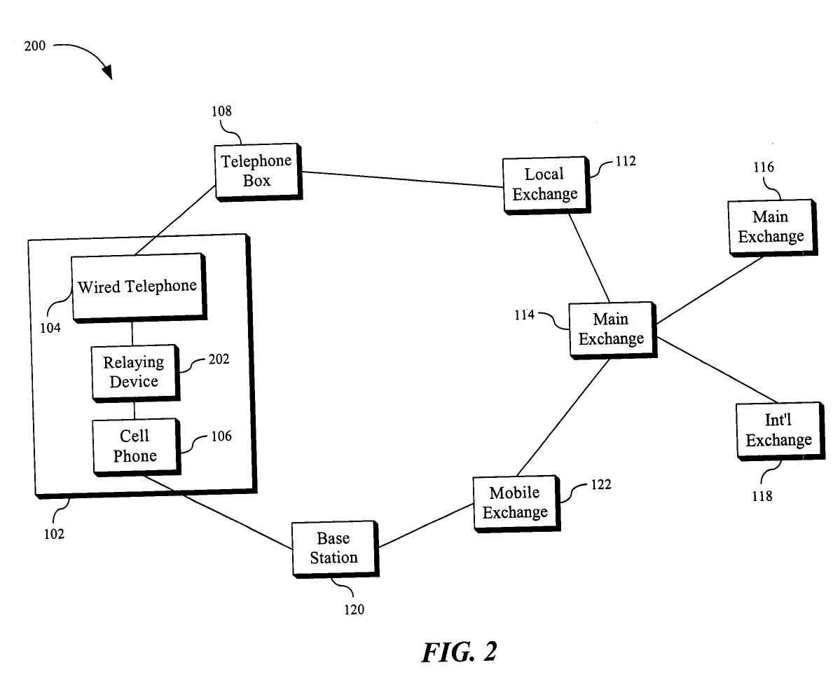

FIG. 2 shows an exemplary telephone network 200 including a mobile telephone relaying device or unit 202 at the user's end 102 in accordance with an exemplary embodiment of the present invention. The relaying device 202 may enable the wired telephone 104 to communicate with the cell phone 106, wirelessly or via hardwire connection or both. For example, when the relaying device 202 is turned on, the user may answer an incoming telephone call to the user's cell phone 106 from the wired telephone 104, and may answer an incoming telephone call to the wired telephone 104 from the user's cell phone 106. In addition, when the relaying device 202 is turned on, the user may make an outgoing telephone call from the wired telephone 104 via the cell phone 106, and may make an outgoing telephone call from the cell phone 106 via the wired telephone 104. In an alternative embodiment, the relaying device 202 may also enable two or more cell phones and two or more wired telephones to communicate with each other.

The relaying device 202 may be standalone or may be part of the wired telephone 104, the mobile telephone 106, or a cradle assembly for receiving the mobile telephone (not shown). For example, the relaying device 202 may be part of a charger cradle assembly. Thus, when the mobile telephone 106 is placed on the charger cradle assembly to be charged, any incoming telephone to the mobile telephone 106 may be routed through the relaying device 202 to the wired telephone 104. The relaying device 202 may also be programmable so that when two or more mobile telephones and two or more wired telephones are communicatively coupled through the relaying device 202, the relaying device 202 may route a telephone call received from a telephone to another specific telephone according to the programmed instruction. For example, the relaying device 202 may forward a telephone call received by a mobile phone to another mobile phone, a wired telephone, or the like. Alternatively, It is understood that the relaying device or unit of the present invention may be applicable to a wide variety of telephones such as a mobile telephone, a regular telephone, a cordless telephone, a satellite telephone, an Internet telephone, and the like, without departing from the scope and spirit of the present invention.

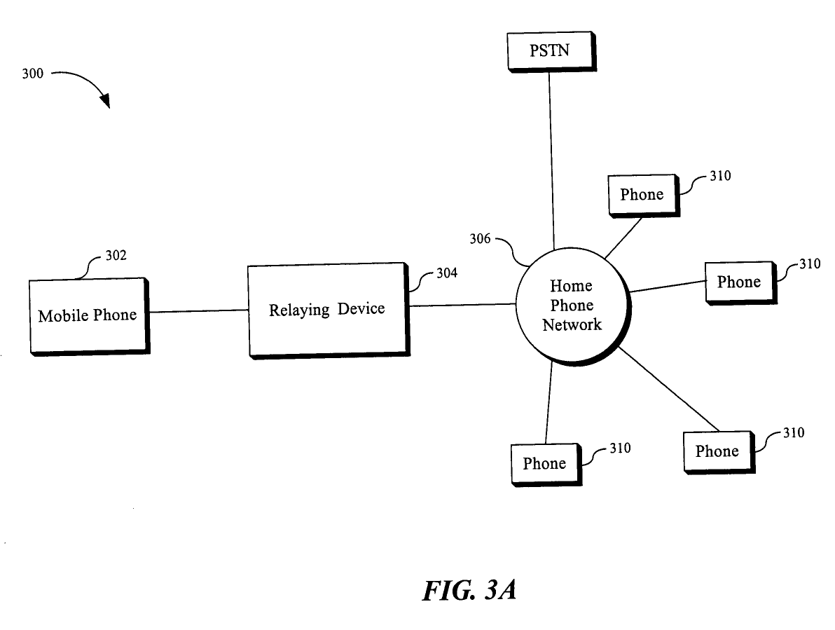

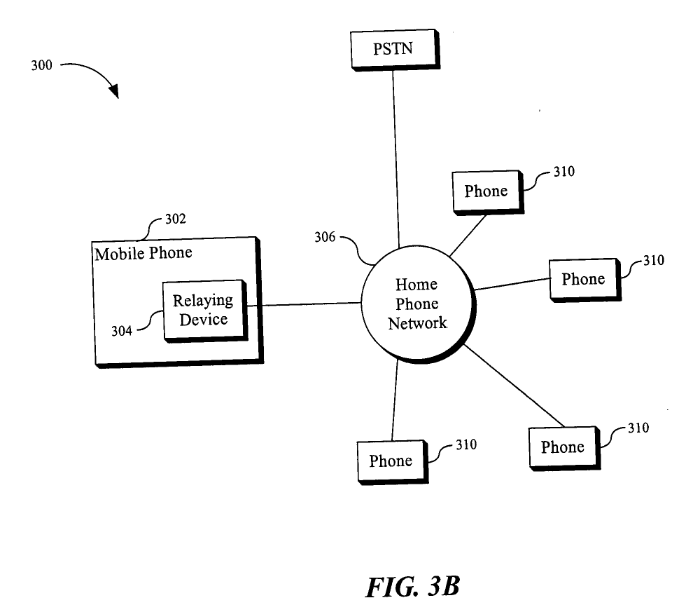

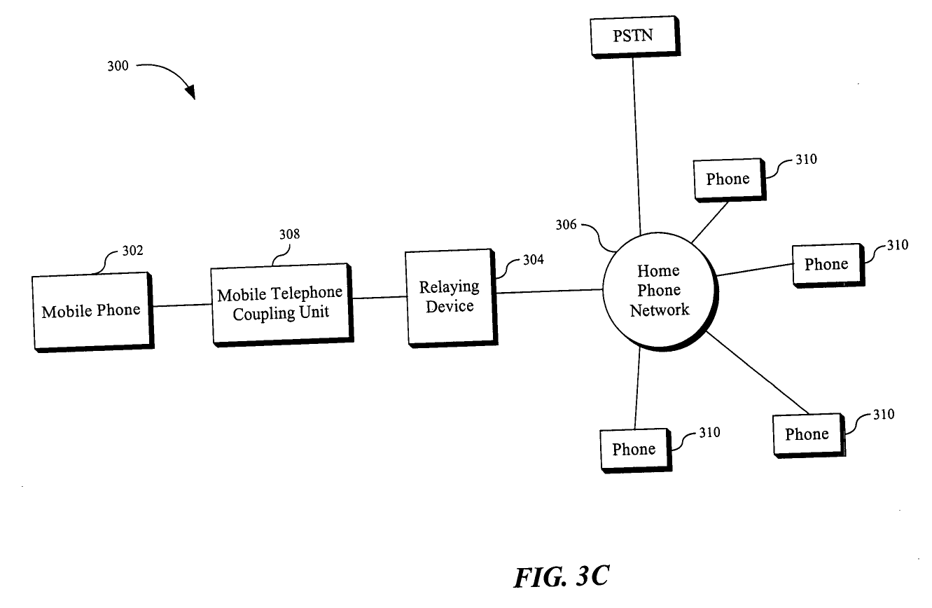

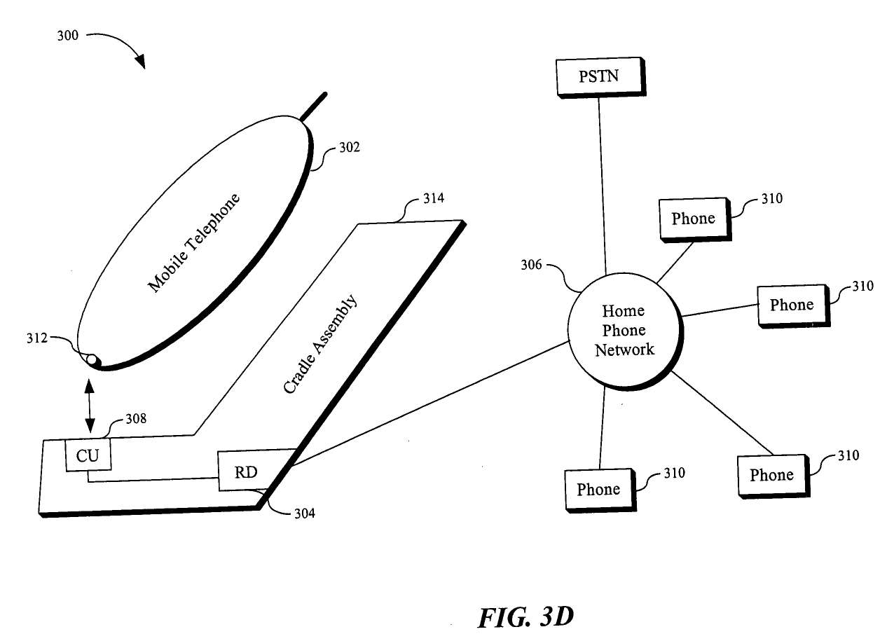

FIG. 3A shows an exemplary telephone network 300 including a mobile telephone relaying device or unit 304 at a user's home in accordance with an exemplary embodiment of the present invention. A part of the wireless mobile telephone system, a mobile telephone or mobile phone 302 may be communicatively coupled to the mobile telephone relaying device 304 preferably through hardwire connection. The relaying device 304 may be communicatively coupled (preferably through hardwire connection) to a wired home telephone network 306 which includes at least one wired telephone 310 and is connected to the wired telephone communication system (e.g., PSTN). The wired home telephone network 306 may employ communication signals having a first format, and the mobile telephone 302 may employ communication signals having a second format. For example, the first format may include a high voltage (e.g., 12 volts or higher), and the second format may include a low voltage (e.g., 3 volts or lower). It is understood that the first format and the second format may include other voltages without departing from the scope and spirit of the present invention.

The mobile telephone 302 may through a signal outlet (not shown in FIG. 3A) output analogue or digital communication signals having the second format. After the relaying device 304 receives such signals from the mobile telephone 302, the relaying device 304 may filter the noise and convert such signals into communication signals having the first format, which are operable by the wired telephone 310. The converse may be also true. That is, after the relaying device 304 receives communication signals having the first format from the wired telephone 310, the relaying device 304 may filter the noise and convert such signals into communication signals having the second format, which are operable by the mobile telephone 302. Thus, the relaying device 304 may transfer communication signals for data, voice, ringer, and the like between the mobile telephone 302 and the wired home telephone network 306 (and, thus the wired telephone 310). This way, a user may use a wired telephone 310 to answer a telephone call received by the mobile telephone 302.

FIG. 3B shows an alternative embodiment of the telephone network 300, wherein the mobile telephone relaying device 304 is part of the mobile telephone 302.

FIG. 3C shows another alternative embodiment of the telephone network 300. Instead of coupling the mobile phone 302 directly to the relaying device 304, in FIG. 3C the mobile phone 302 is coupled to a mobile telephone coupling unit 308. The mobile telephone coupling unit 308 may be used for interconnecting the mobile telephone 302 to the relaying unit 304 for transmission of communication signals between the relaying unit 304 and the mobile telephone 302. The wired home telephone network 306 may employ communication signals having a first format, and the communication signals transferred between the mobile phone 302 and the mobile telephone coupling unit 308 and between the mobile telephone coupling unit 308 and the relaying device 304 may have a second format. For example, the first format may include a high voltage (e.g., 12 volts or higher), and the second format may include a low voltage (e.g., 3 volts or lower). It is understood that the first format and the second format may include other voltages without departing from the scope and spirit of the present invention.

FIG. 3D shows a further embodiment of the telephone network 300. The mobile telephone coupling unit 308 and the relaying device 304 may be provided by a cradle assembly 314. The cradle assembly may be used to charge the mobile telephone 302 and may be coupled to the home phone network 306 preferably through hardwire connection. The mobile telephone 302 may through a signal outlet 312 output analogue or digital communication signals to the cradle assembly 314. The mobile telephone coupling unit 308 may be used for interconnecting the mobile telephone 302 to the relaying unit 304 for transmission of communication signals between the relaying unit 304 and the mobile telephone 302 (via the signal outlet 312). The wired home telephone network 306 may employ communication signals having a first format, and the communication signals transferred between the mobile phone 302 and the mobile telephone coupling unit 308 and between the mobile telephone coupling unit 308 and the relaying device 304 may have a second format. For example, the first format may include a high voltage (e.g., 12 volts or higher), and the second format may include a low voltage (e.g., 3 volts or lower). It is understood that the first format and the second format may include other voltages without departing from the scope and spirit of the present invention.

In the telephone network 300 shown in FIGS. 3A through 3D, the relaying unit 304 may provide electrical power for powering the wired telephone 310. Alternatively, the relaying unit 304 may be powered by the wired home telephone network 306. The relaying unit 304 may detect connection of the mobile telephone 302 to the relaying unit 304 and thereafter cause communication with the wired telephone 310 to be provided through the wireless mobile telephone system via the mobile telephone 302. The relaying unit 304 may cause the wired home telephone network 306 to be disconnected from the wired telephone communication system (e.g., PSTN). The relaying unit 304 may include a switch for switching between communication via the wireless mobile telephone system and the wired telephone communication system (e.g., PSTN).

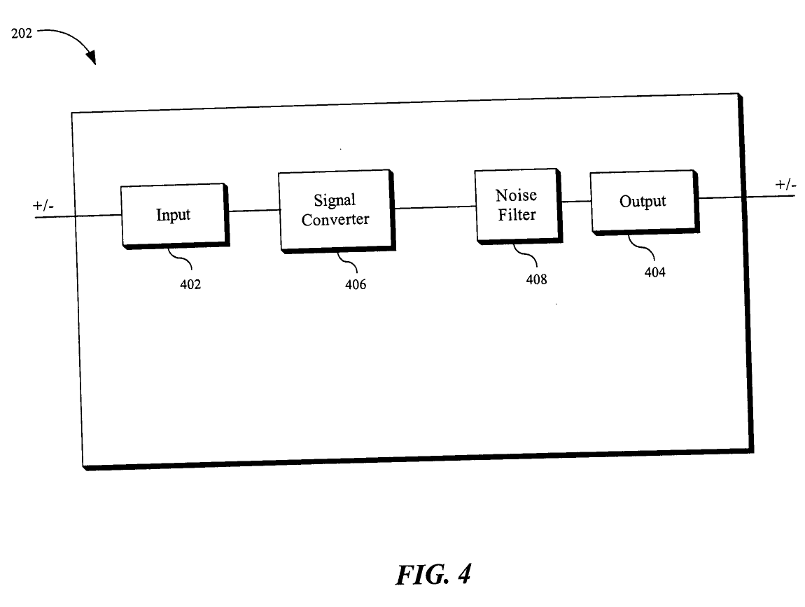

FIG. 4 illustrates an exemplary embodiment of the mobile telephone relaying device or relaying unit 202 shown in FIG. 2 in accordance with the present invention. The relaying device 202 may be applicable to the telephone network 300 shown in FIGS. 3A through 3D (i.e., the relaying device 202 may be the relaying unit 304 shown in FIGS. 3A through 3D). The relaying device 202 may be used to route a telephone call between a mobile telephone and a second telephone such as a regular telephone, a cordless telephone, another mobile telephone, and the like. The relaying device 202 may include an input 402, an output unit 404, a signal converter 406, and a noise filter 408. The input 402 may receive communication signals (e.g., in a certain format) for a telephone call from a first telephone. The signal converter 406 may transform the received communication signals into new communication signals (e.g., in a different format) which are capable of being transformed by a second telephone into the original telephone call (e.g., voice). The signal converter 406 may include at least one of a D/A (digital/analogue) and an A/D (analogue/digital) converter. The noise filter 408 may filter out noise from communication signals. The noise filter 408 may be placed in front of or behind the signal converter 406 without departing from the scope and spirit of the present invention. The output 304 may output the new communication signals to the second telephone so that the original telephone call received by the first telephone now may be routed to the second telephone. The relaying device 202 may be used to transfer communication signals for data, voice, ringer, and the like between a mobile telephone and a wired telephone. The relaying unit 202 may include a switching assembly (not shown) for detecting connection of a mobile telephone to a mobile telephone coupling unit and thereafter causing communication with the wired telephone to be provided through the wireless mobile telephone system via the wireless telephone.

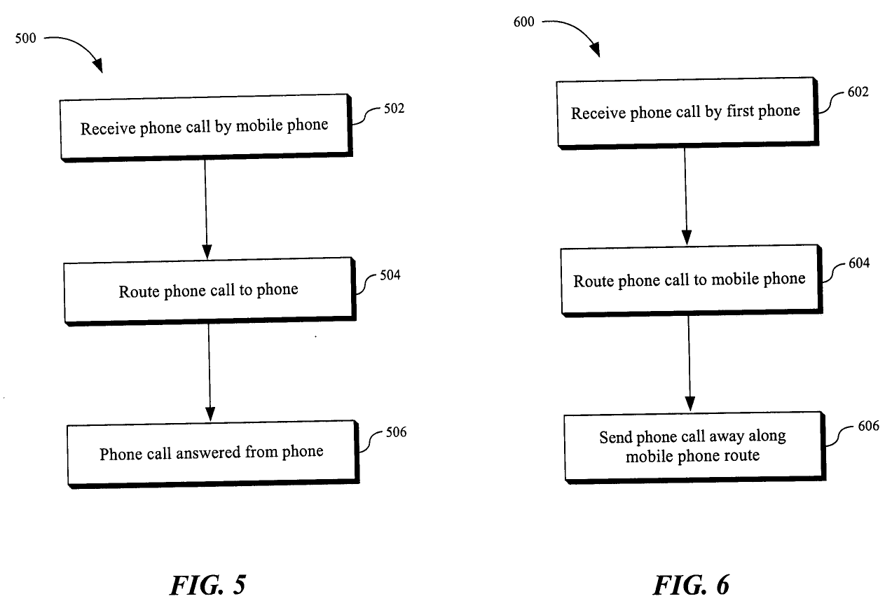

FIG. 5 is a flow chart showing a process 500 for routing an incoming telephone call in accordance with an exemplary embodiment of the present invention. The process 500 may start with a step 502 in which a telephone call is received by a mobile telephone such as a cell telephone, a satellite telephone, and the like. Next, in step 504, the telephone call may be routed to a second telephone (e.g., through a mobile telephone relaying device). The second telephone may be a regular telephone, a cordless telephone, another mobile telephone, and the like. Preferably the mobile telephone and the second telephone are both at a user's end. Then, the telephone call may be answered from the second telephone 506.

FIG. 6 is a flow chart showing a process 600 for routing an outgoing telephone call in accordance with an exemplary embodiment of the present invention. The process 600 may start with a step 602 in which a telephone call is received by a first telephone such as a regular telephone, a cordless telephone, a mobile telephone, and the like. Next, in step 604, the telephone call may be routed to a mobile telephone (e.g., through a mobile telephone relaying device). Preferably the mobile telephone and the second telephone are both at a user's end. Then, the telephone call is sent away along the mobile telephone route 606.

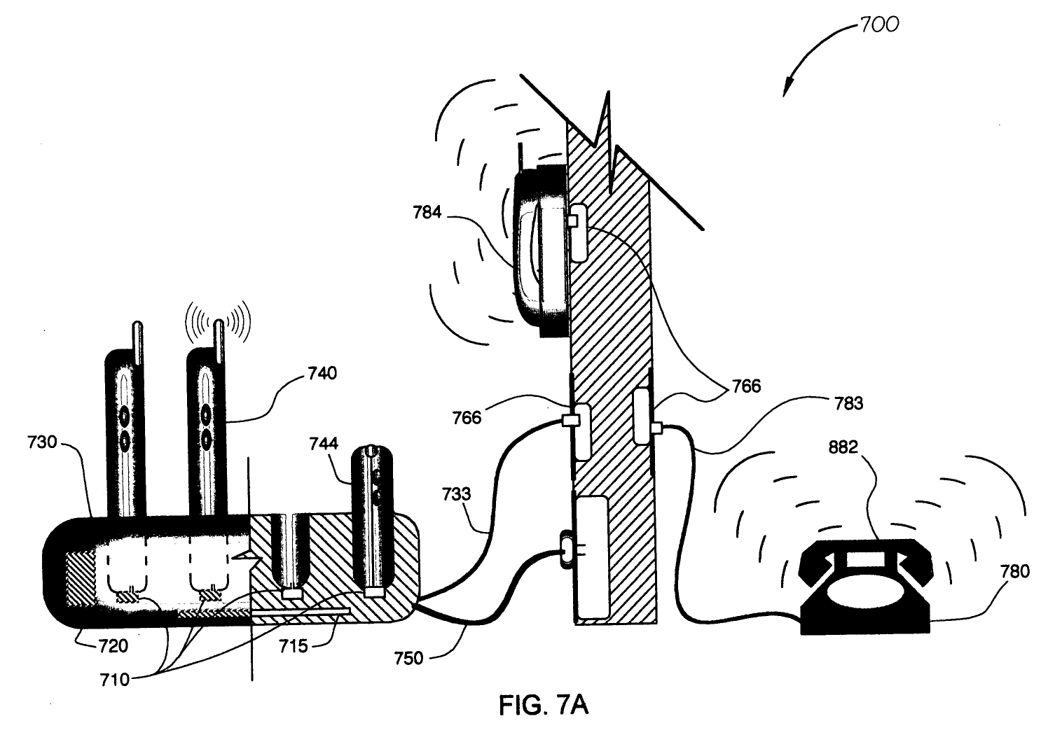

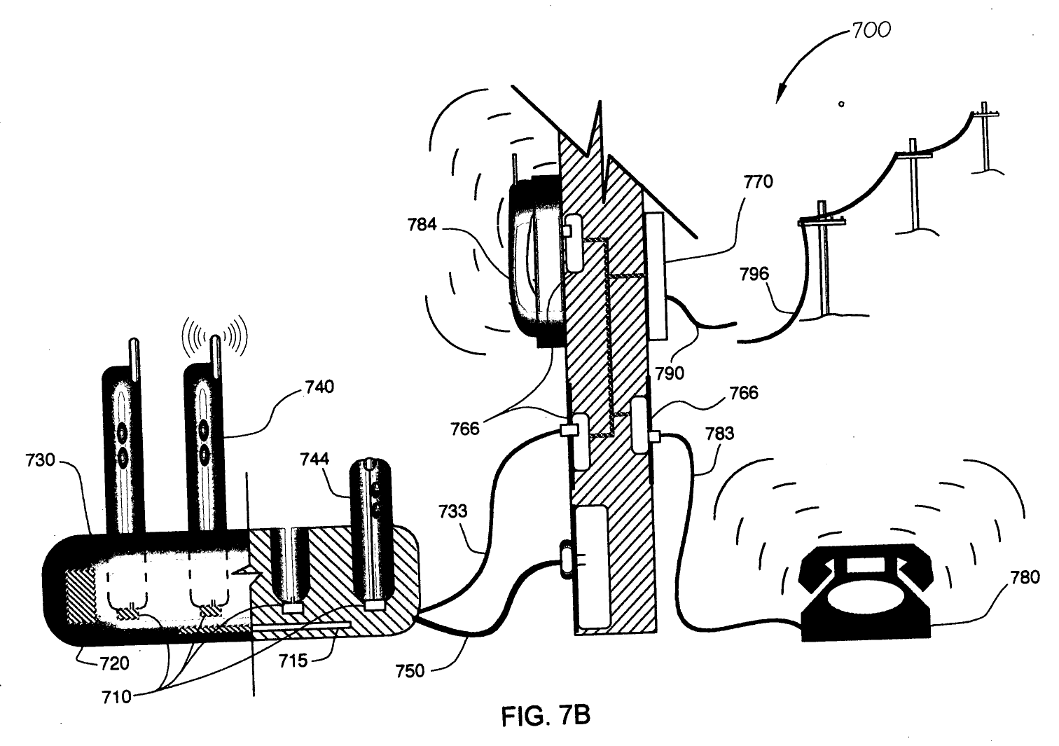

FIG. 7A shows an exemplary telephone network 700 where an incoming telephone phone call is received by a mobile phone 740 in accordance with an exemplary embodiment of the present invention. As shown, the mobile phone 740 may be placed on a cradle assembly 730. The cradle assembly 730 may hold an additional mobile phone or PDA (personal digital assistant) 744. A signal outlet of the mobile phone 740 (not shown) may be coupled to a mobile telephone coupling unit 710. The mobile telephone coupling unit 710 may be coupled to a mobile telephone relaying device (or unit) 720. The cradle assembly 730 may include a memory device 715 for storing relevant information. Preferably, the mobile telephone coupling unit 710, the mobile telephone relaying unit 720, and the memory device 715 are placed inside the cradle assembly 730. The cradle assembly 730 may be powered through an electrical cord 750 and a wall power outlet. The cradle assembly 730 may be through hardwire 733 coupled to a phone jack 766. All the phone jacks 766 may be internally wired together. As shown, a cordless phone 784 may be connected to a phone jack 766, and a regular phone 780 may be connected to a phone jack 766 through hardwire 783. When the mobile phone 740 receives a telephone call, the communication signals for the telephone call may be communicated, through the mobile telephone coupling unit 710, to the mobile telephone relaying unit 720. Such communication signals may have a certain format (e.g., a lower voltage, and the like). After receiving such communication signals, the mobile telephone relaying unit 720 may convert the communication signals into new communication signals having a different format (e.g., a higher voltage, and the like) and send the new communication signals through hardwire 733 to the phone jacks 766. The cordless phone 784 and the regular telephone 780 may convert the new communication signals into the original phone call. Thus, a user may use the cordless phone 784 and the regular telephone 780 to answer the phone call received by the mobile phone 740. It is understood by those of ordinary skill in the art that the mobile telephone relaying unit 720 may also forward telephone calls received by all mobile phones, PDAs, and the like placed on the cradle assembly 730 to the regular telephone 780 and/or the cordless telephone 784. Then a user may pick which phone call to answer from the regular telephone 780 and/or the cordless telephone 784.

FIG. 7B shows an alternative embodiment of the telephone network 700 in accordance with an exemplary embodiment of the present invention. As shown, the phone jacks 766 may be internally wired together to a telephone box 770. However, the hardwire 790 connected to the telephone box 770 is disconnected from the hardwire 796 which is connected to the PSTN. Thus, using the mobile telephone relaying device 720, a user may organize all the telephones at his end into a telephone network and answer a phone call received on a mobile phone from a wired phone. In the meantime, all the wired telephones in the telephone network may be disconnected from the wired telephone route (part of the PSTN).

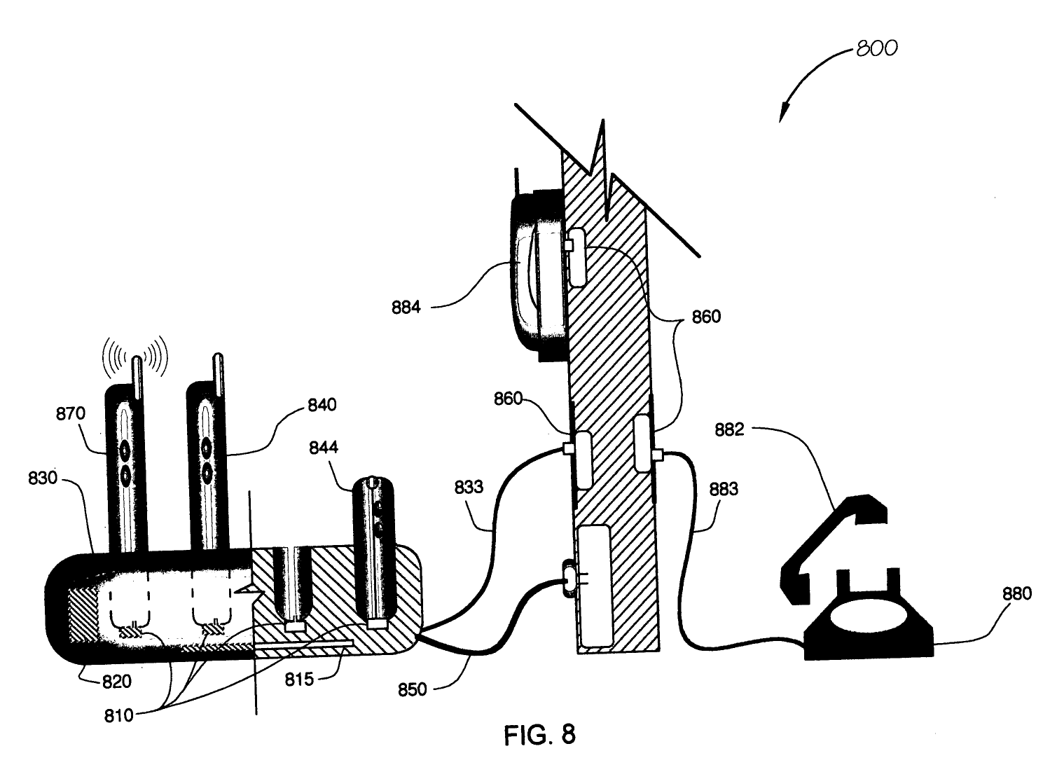

FIG. 8 shows an exemplary telephone network 800 where an outgoing telephone phone call is made from a wired telephone 880 in accordance with an exemplary embodiment of the present invention. The telephone network 800 is similar to the telephone network 700 shown in FIGS. 7A and 7B. As shown in FIG. 8, a mobile phone 870 may be placed on a cradle assembly 830. The cradle assembly 830 may hold an additional mobile phone 840 and a PDA (personal digital assistant) 844. A signal outlet of the mobile phone 870 (not shown) may be coupled to a mobile telephone coupling unit 810. The mobile telephone coupling unit 810 may be coupled to a mobile telephone relaying device (or unit) 820. The cradle assembly 830 may include a memory device 815 for storing relevant information. Preferably, the mobile telephone coupling unit 810, the mobile telephone relaying unit 820, and the memory device 815 are placed inside the cradle assembly 830. The cradle assembly 830 may be powered through an electrical cord 850 and a wall power outlet. The cradle assembly 830 may be through hardwire 833 coupled to a phone jack 860. All the phone jacks 860 may be internally wired together. As shown, a cordless phone 884 may be connected to a phone jack 860, and the regular phone 880 may be connected to a phone jack 860 through hardwire 883. When a user lifts a handset 882 of the regular phone 880 to make a phone call, the communication signals for the telephone call may be communicated, through the hardwire 883, the phone jack 860, and the hardwire 833, to the mobile telephone relaying unit 820. Such communication signals may have a certain format (e.g., a higher voltage, and the like). After receiving such communication signals, the mobile telephone relaying unit 820 may convert the communication signals into new communication signals having a different format (e.g., a lower voltage, and the like) and route the new communication signals through the mobile telephone coupling unit 810 to an appropriate mobile phone. The receiving mobile phone may then convert the new communication signals into the original phone call. Thus, using the mobile telephone relaying device 820, a user may use a wired telephone to make a free long distance telephone call through a mobile telephone via the wireless mobile telephone system, utilizing the mobile telephone's free long distance telephone calling plan. The relaying device 820 may also enable two or more mobile telephones and two or more wired phones to communicate with each other.

It is understood that the telephone networks 700 and 800 shown in FIGS. 7A, 7B and 8 are exemplary only and are not intended as an architecture limitation to the present invention. The present mobile telephone relaying device may convert communication signals have a certain format to communication signals having a different format. The present invention may convert communication signals received by a telephone, a PDA, a computer and the like into communication signals operable by another telephone, PDA, computer, and the like.

It is understood that the specific order or hierarchy of steps in the methods disclosed are examples of exemplary approaches. Based upon design preferences, it is understood that the specific order or hierarchy of steps in the method can be rearranged while remaining within the scope of the present invention. The accompanying method claims present elements of the various steps in a sample order, and are not meant to be limited to the specific order or hierarchy presented.

It is believed that the present invention and many of its attendant advantages will be understood by the foregoing description. It is also believed that it will be apparent that various changes may be made in the form, construction and arrangement of the components thereof without departing from the scope and spirit of the invention or without sacrificing all of its material advantages. The form herein before described being merely an explanatory embodiment thereof, it is the intention of the following claims to encompass and include such changes.

What is claimed is:

1. A mobile telephone relaying system for relaying communication signals between mobile telephone capable of wireless communication with a wireless mobile telephone communication system and a wired telephone in a wired local telephone network providing communication between the wired telephone and a wired telephone communication system, the wired telephone network employing communication signals having a first format and the mobile telephone communication signals having a second format, comprising:
a relaying unit coupled to the wired local telephone network for relaying communication signals between the mobile telephone and the wired local telephone network for communication with the wired telephone;
wherein the relaying unit converts communication signals received from the mobile telephone from the second format to the first format for transmission to the wired local telephone network and converts communication signals received from the wired local telephone network by the wired telephone from the first format to the second format for transmission to the mobile telephone.

2. The mobile telephone relaying system as claimed in claim 1, wherein the first format comprises at least a first voltage and the second format comprises at least a second voltage.

3. The mobile telephone relaying system as claimed in claim 2, wherein the first voltage is higher than the second voltage.

4. The mobile telephone relaying system as claimed in claim 3, wherein the relaying unit provides electrical power for powering the wired telephone.

5. The mobile telephone relaying system as claimed in claim 1, wherein the relaying unit detects connection of the mobile telephone to the relaying unit and thereafter causes communication with the wired telephone to be provided through the wireless mobile telephone system via the wireless telephone.

6. The mobile telephone relaying system as claimed in claim 5, wherein the relaying unit causes the wired telephone network to be disconnected from the wired telephone communication system.

7. The mobile telephone relaying system as claimed in claim 1, wherein the relaying unit comprises a signal converter for converting communication signals having the second format to the first format and communication signals having the first format to the second format.

8. The mobile telephone relaying system as claimed in claim 7, wherein the signal converter comprises at least one of a digital to analog converter and an analog to digital converter.

9. The mobile telephone relaying system as claimed in claim 7, wherein the relaying unit further comprises a noise filter for filtering noise from communication signals having the first format.

10. The mobile telephone relaying system as claimed in claim 7, wherein the relaying unit further comprises a switch for switching between communication via the wired telephone communication system and the wireless mobile communication system.

11. The mobile telephone relaying system as claimed in claim 1, further comprises a cradle assembly for receiving the mobile telephone, the relaying unit being provided by the cradle assembly.

12. The mobile telephone relaying system as claimed in claim 1, wherein the relaying unit is powered by the wired telephone communication system via the wired local telephone network.

13. A mobile telephone relaying system for relaying communication signals between a mobile telephone capable of wireless communication with a wireless mobile telephone communication system and a wired telephone in a wired local telephone network providing communication between the wired telephone and a wired telephone communication system, the wired telephone network employing communication signals having a first format and the mobile telephone communication signals having a second format, comprising:
a relaying unit coupled to the wired local telephone network for relaying communication signals between the mobile telephone and the wired local telephone network for communication with the wired telephone; and
a mobile telephone coupling unit for interconnecting the mobile telephone to the relaying unit for transmission of communication signals having the second format between the relaying unit and the mobile telephone,
wherein the relaying unit converts communication signals received from the mobile telephone coupling unit from the second format to the first format for transmission to the wired local telephone network and converts communication signals received to the wired local telephone network from the first format to the second format for transmission to the mobile telephone via the mobile telephone coupling unit for allowing communication via wireless telephone network using the wired telephone.

14. The mobile telephone relaying system as claimed in claim 13, wherein the first format comprises at least a first voltage and the second format comprises at least a second voltage.

15. The mobile telephone relaying system as claimed in claim 14, wherein the first voltage is higher than the second voltage.

16. The mobile telephone relaying system as claimed in claim 15, wherein the relaying unit provides electrical power for powering the wired telephone.

17. The mobile telephone relaying system as claimed in claim 13, wherein one of the mobile telephone coupling unit and the relaying unit detects connection of the mobile telephone to the mobile telephone coupling unit and thereafter causes communication with the wired telephone to be provided through the wireless mobile telephone system via the wireless telephone.

18. The mobile telephone relaying system as claimed in claim 17, wherein the relaying unit causes the wired telephone network to be disconnected from the wired telephone communication system.

19. The mobile telephone relaying system as claimed in claim 13, wherein the relaying unit comprises a signal converter for converting communication signals having the second format to the first format and communication signals having the first format to the second format.

20. The mobile telephone relaying system as claimed in claim 19, wherein the relaying unit further comprises a noise filter for filtering noise from communication signals having the first format.

21. The mobile telephone relaying system as claimed in claim 13, further comprises a cradle assembly for receiving the mobile telephone, the mobile telephone coupling unit being provided by the cradle assembly.

22. The mobile telephone relaying system as claimed in claim 21, wherein the relaying unit is provided by the cradle assembly.

23. The mobile telephone relaying system as claimed in claim 13, wherein the relaying unit is powered by the wired telephone communication system via the wired local telephone network.

24. A mobile telephone relaying system for relaying communication signals between a mobile telephone capable of wireless communication with a wireless mobile telephone communication system and a wired telephone in a wired local telephone network the wired local telephone network for providing communication between the wired telephone and a wired telephone communication system, the wired telephone network employing communication signals having a first format and the mobile telephone transmitting communication signals having a second format to the mobile telephone coupling unit, comprising:
means, coupled to the wired local telephone network, for relaying communication signals between the mobile telephone and the wired local telephone network; and
means for interconnecting the mobile telephone to the relaying means,
wherein the relaying means converts communication signals transmitted to the interconnecting means by the mobile telephone from the second format to the first format and converts communication signals transmitted to the wired local telephone network by the wired telephone from the first format to the second format for allowing communication via wireless telephone network using the wired telephone.

25. A method for relaying communication signals between a mobile telephone capable of wireless communication with a wireless mobile telephone communication system and a wired telephone in a wired local telephone network providing communication between the wired telephone and a wired telephone communication system, the wired telephone network employing communication signals having a first format the mobile telephone communication signals having a second format, comprising:
coupling the mobile telephone to a mobile telephone coupling unit for interconnecting the mobile telephone to a relaying unit for transmission of communication signals having the second format between the relaying unit and the mobile telephone; and
relaying communication signals between the mobile telephone and the wired local telephone network via the relaying unit for communication with the wired telephone,
wherein the relaying unit converts communication signals transmitted to the mobile telephone coupling unit by the mobile telephone from the second format to the first format for transmission to the wired local telephone network and converts communication signals transmitted to the wired local telephone network by the wired telephone from the first format to the second format for transmission to the mobile telephone for allowing communication via the wired telephone using the wireless telephone network.

26. The method as claimed in claim 25, wherein the first format comprises at least a first voltage and the second format comprises at least a second voltage.

27. The method as claimed in claim 26, wherein the first voltage is higher than the second voltage.

28. The method as claimed in claim 25, further comprising detecting connection of the mobile telephone to the mobile telephone coupling unit and thereafter causing communication with the wired telephone to be provided through the wireless mobile telephone system via the wireless telephone.

29. The method as claimed in claim 28, further comprising causing the wired telephone network to be disconnected from the wired telephone communication system.

30. The mobile telephone relaying system as claimed in claim 13, wherein the step of coupling the mobile telephone to the mobile telephone coupling unit comprises placing the mobile telephone in a cradle assembly.

31. A mobile telephone relaying unit for relaying communication signals between mobile telephone capable of wireless communication with a wireless mobile telephone communication system and a wired telephone in a wired local telephone network providing communication between the wired telephone and a wired telephone communication system, the wired telephone network employing communication signals having a first format and the mobile telephone communication signals having a second format, comprising:
a signal converter for relaying communication signals between the mobile telephone and the wired local telephone network for communication with the wired telephone; and
a switching assembly for detecting connection of the mobile telephone to the mobile telephone coupling unit and thereafter causing communication with the wired telephone to be provided through the wireless mobile telephone system via the wireless telephone,
wherein the signal converter converts communication signals received from the mobile telephone from the second format to the first format for transmission to the wired local telephone network and converts communication signals received the wired local telephone network by the wired telephone from the first format to the second format for transmission to the mobile telephone.

32. The mobile telephone relaying unit as claimed in claim 31, wherein the first format comprises at least a first voltage and the second format comprises at least a second voltage.

33. The mobile telephone relaying unit as claimed in claim 32, wherein the first voltage is higher than the second voltage.

34. The mobile telephone relaying unit as claimed in claim 31, wherein the switching assembly causes the wired telephone network to be disconnected from the wired telephone communication system.

35. The mobile telephone relaying unit as claimed in claim 31, further comprising a cradle assembly for receiving the mobile telephone.

36. The mobile telephone relaying unit as claimed in claim 31, further comprising a noise filter for filtering noise from communication signals having the first format.

37. A method for routing an incoming phone call, comprising:
receiving a phone call by a mobile phone; and
routing said phone call to a second phone via a mobile phone relaying device.

38. The method of claim 37, wherein said second phone is selected from a group consisting of a regular phone, a cordless phone, a cell phone, a satellite phone, and an Internet phone.

39. The method of claim 37, wherein said mobile phone is a cell phone.

40. The method of claim 37, wherein said mobile phone relaying device is at a user's end.

41. The method of claim 37, further comprising answering said phone call from said second phone.

42. A method for routing an outgoing phone call, comprising:
receiving a phone call by a first phone; and
routing said phone call to a mobile phone via a mobile phone relaying device.

43. The method of claim 42, wherein said first phone is selected from a group consisting of a regular phone, a cordless phone, a cell phone, a satellite phone, and an Internet phone.

44. The method of claim 42, wherein said mobile phone is a cell phone.

45. The method of claim 42, wherein said mobile phone relaying device is at a user's end.

46. The method of claim 42, further comprising sending said phone call away along a mobile phone route.

47. A telephone network, comprising:
a mobile phone; and
a second phone communicatively coupled to said mobile phone via a mobile phone relaying device, said mobile phone relaying device being at a user's end,
wherein said mobile phone relaying device routes a phone call between said mobile phone and said second phone.

48. The telephone network of claim 47, wherein said second phone is selected from a group consisting of a regular phone, a cordless phone, a cell phone, a satellite phone, and an Internet phone.

49. The telephone network of claim 47, wherein said mobile phone relaying device is part of said mobile phone.

50. The telephone network of claim 47, wherein said mobile phone relaying device is part of said second phone.

51. The telephone network of claim 47, wherein said mobile phone relaying device is a stand alone product.

52. The telephone network of claim 47, wherein said mobile phone is a cell phone.

53. The telephone network of claim 52, wherein said mobile phone relaying device is part of a charger cradle assembly so that when said cell phone is placed on said charger cradle assembly to be charged, an incoming phone call to said cell phone is routed to said second phone.
